(19) United States
(12) Patent Application Publication
(10) Pub. No.: US 2019/0163236 A1
(43) Pub. Date: May 30, 2019

(54) LAPTOP COMPUTER ACCESSORY

(71) Applicant: Roger D. Van Pelt, Rochester, MI (US)

(72) Inventor: Roger D. Van Pelt, Rochester, MI (US)

(21) Appl. No.: 16/198,112

(22) Filed: Nov. 21, 2018

Related U.S. Application Data
(60) Provisional application No. 62/590,852, filed on Nov. 27, 2017.

(51) Int. Cl. G06F 1/16; G06F 1/26

(52) U.S. Cl. CPC G06F 1/1616; H01R 25/006; G06F 1/263; G06F 1/1607

(57) ABSTRACT

A laptop accessory comprising a battery disposed within or taking the form of a laptop cover. The laptop cover includes a plurality of clips configured to removably mount the laptop cover to a monitor of a laptop computer in a mounted position, with the monitor supporting the laptop cover in the mounted position. The laptop cover includes a first electrical connector for providing electrical power from the battery to the laptop computer.

### CROSS-REFERENCE TO RELATED APPLICATIONS

The subject patent application claims priority to and all the benefits of U.S. Provisional Patent Application No. 62/590,852 filed on Nov. 27, 2017, which is herein incorporated by reference in its entirety.

### BACKGROUND

Laptop computers are widely used. There are several solutions for providing electrical power for laptop computers. For example, the laptop computer can include an integral power source, such as a battery. The battery can be disposed within a chassis of the laptop computer, such as a base of the laptop computer.

In addition, an electrical outlet, such as a wall socket, can provide electrical power to the laptop computer. If the laptop computer also includes an integral power source, e.g., a battery, the wall socket can be used to charge the battery while also powering the laptop computer.

Wall sockets, however, are not available at all locations. Moreover, an integral power source such as a battery can only power the laptop computer for a finite time, which is typically a function of how the laptop computer is used. Consequently, laptop computer users may carry an auxiliary power source, such as a replacement battery, to power their laptop computers when the integral power source is exhausted.

### BRIEF DESCRIPTION OF THE DRAWINGS

FIG. 1 is a perspective view of one example of a laptop computer accessory illustrating a surface of a monitor side of a laptop cover, with a battery disposed within the laptop cover shown in broken line.

FIG. 2 is an orthogonal view of the monitor side of the example of the laptop computer accessory illustrated in FIG. 1.

FIG. 3 is an orthogonal view of a side of the laptop computer accessory opposing the monitor side of the laptop computer accessory illustrated in FIG. 1.

FIG. 4 is an orthogonal view of a first end of the laptop computer accessory illustrated in FIG. 1.

FIG. 5 is an orthogonal view of a second end of the laptop computer accessory illustrated in FIG. 1.

FIG. 6 is an orthogonal view of a top end of the laptop computer accessory illustrated in FIG. 1.

FIG. 7 is an orthogonal view of a bottom end of the laptop computer accessory illustrated in FIG. 1.

FIG. 8 is a perspective view of a laptop computer and a laptop computer accessory.

FIG. 9 is a perspective view of a laptop computer and a laptop computer accessory removably mounted on the laptop computer.

FIG. 10 is another perspective view of the laptop computer and the laptop computer accessory removably mounted on the laptop computer illustrated in FIG. 9.

### DETAILED DESCRIPTION

With reference to the Figures, wherein like numerals indicate like parts throughout the several views, a laptop computer accessory 10 includes a battery 12 disposed within or taking the form of a laptop cover 14, a plurality of clips 16 configured to removably mount the laptop cover 14 to a monitor 42 of a laptop computer 40, and a first electrical connector 18 for providing electrical power from the battery 12 to the laptop computer 40.

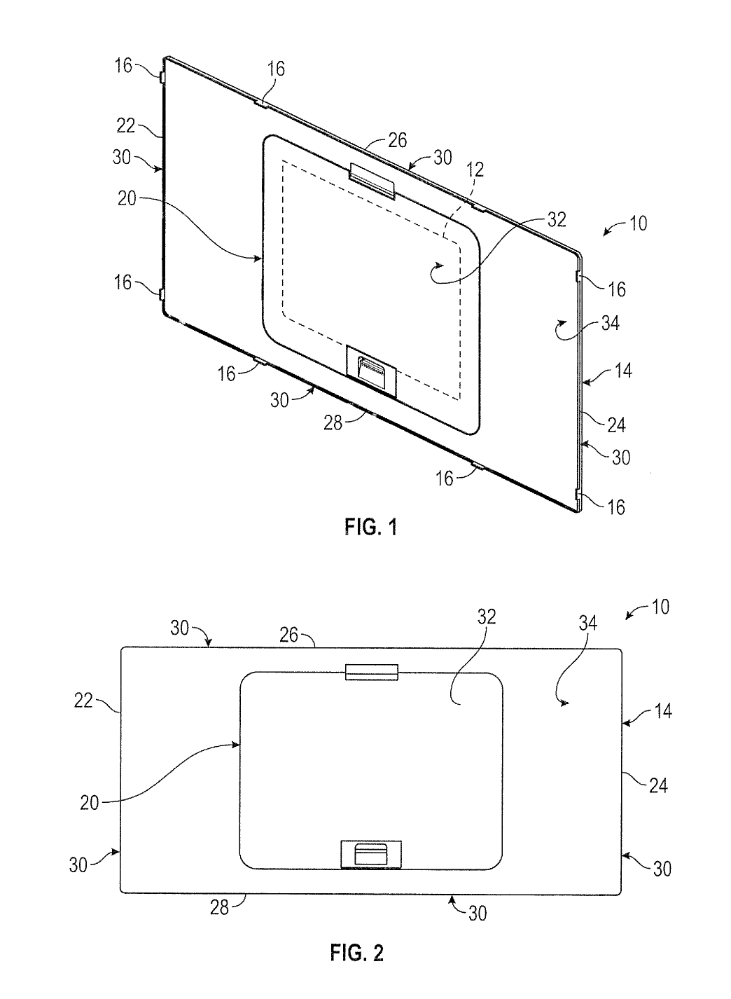

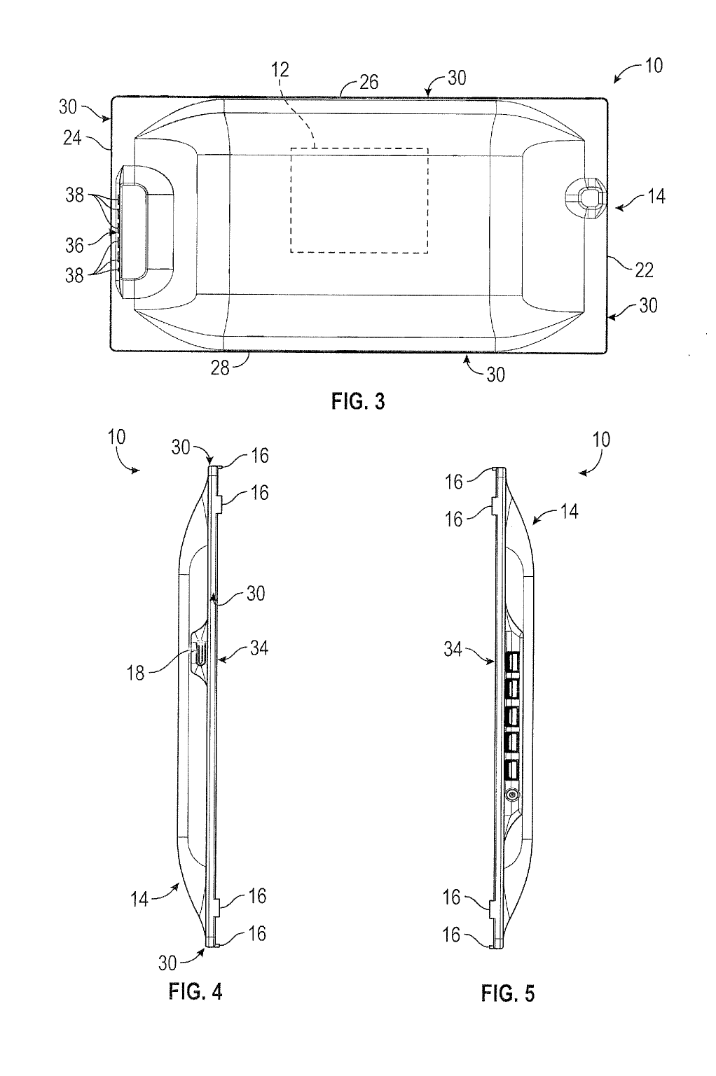

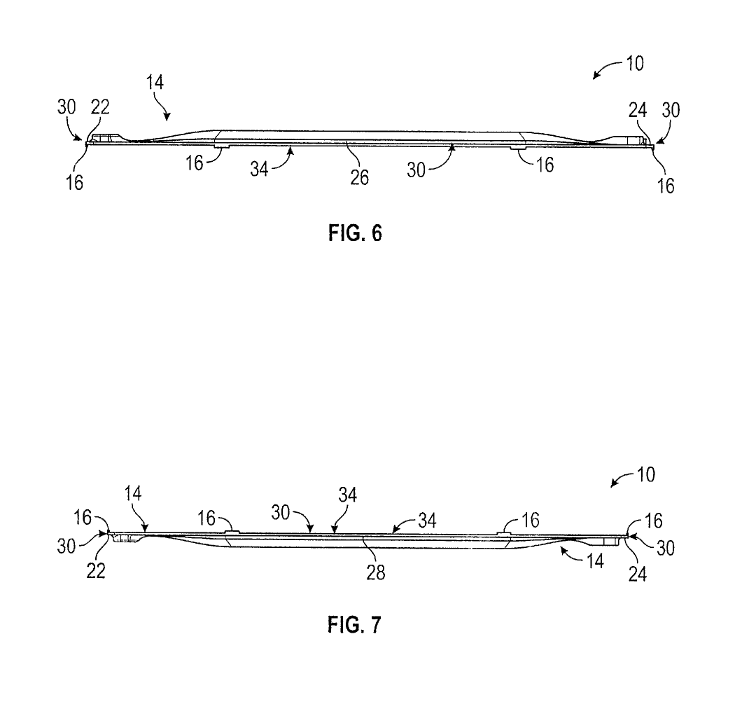

FIGS. 1-7 illustrate an example of the laptop computer accessory 10. In this example, the battery 12 is disposed within the laptop cover 14. The laptop cover 14 includes an opening 20. The opening 20 is configured, e.g., appropriately sized, to allow replacement of the battery 12 with another power source using the opening 20. The other power source can be, e.g., a replacement battery.

The example of the laptop computer accessory 10 illustrated in FIGS. 1-10 can be provided in a various shapes and sizes to accommodate all varieties of laptop computers. In this example, the laptop computer accessory 10 includes a laptop cover 14 having a generally rectangular shape, with a first end 22, a second end 24, a top end 26, and a bottom end 28.

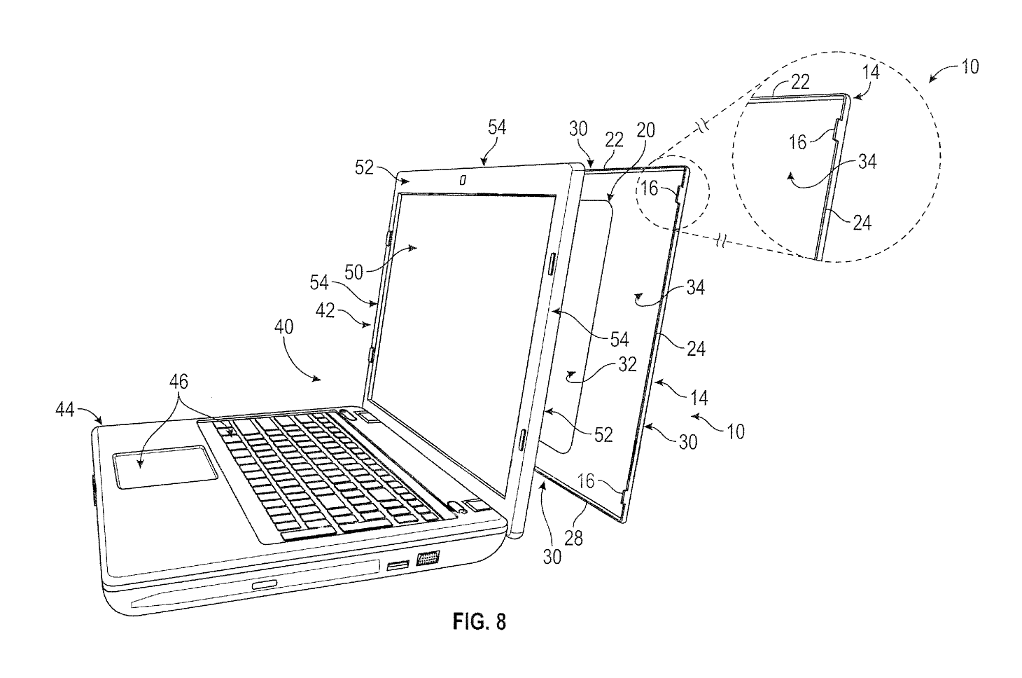

As shown in FIGS. 1-3, the laptop cover 14 can define a perimeter 30. The perimeter 30 can be of a complementary shape and size to a shape and size of a perimeter 54 of the monitor 42 of the laptop computer 40, as shown in FIGS. 8-10. One or more of the plurality of clips 16 can be attached to, e.g., formed integrally with, the perimeter 30 of the laptop cover 14. In this way, the laptop computer accessory 10 can be removably mounted to and retained by the monitor 42 of the laptop computer 40 via, e.g., a press fit.

While the example of the laptop computer accessory 10 shown in the Figures is configured to be removably mountable on monitors of a particular size and shape, e.g., a 15-inch monitor with a generally rectangular shape, the laptop computer accessory 10 can be configured to be modifiable to accommodate a range of monitors, e.g., 13-inch, 15-inch and 17-inch monitors.

For example, the laptop cover 14 can include one or more interlocking sleeve arrangements. The user is then able to re-size a length and/or a width of the laptop cover 14. Additionally and alternatively, one or more of the plurality of clips 16 can be slidable relative the laptop cover 14, thereby allowing a user to removably mount the laptop computer accessory 10 to monitors of differing sizes and shapes.

Referring to FIGS. 1 and 2, the laptop cover 14 includes the opening 20. As discussed, the opening 20 is appropriately sized to allow removal and replacement of the battery 12. The laptop cover 14 can support a plate 32 covering at least a portion of the opening 20. The plate 32 can be moveable between a first position and a second position.

In FIGS. 1 and 2, the plate 32 is shown in the first position, covering the opening 20. In this way, the plate 32 assists in retaining the battery 12 disposed in the opening 20 of the laptop cover 14. In the second position, the plate 32 is moved from the opening 20 to allow removal of the battery 12 and/or replacement of the battery 12 with another power source.

As shown in FIGS. 1, 2 and 8, the laptop cover 14 includes a surface 34. The surface 34 can include a shape, e.g., a depression in the surface 34 of the laptop cover 14 between the first end 22 and the second end 24, and between the top end 26 and the bottom end 28. The shape of the surface 34 can be complementary to a shape of, e.g., an exterior surface of the monitor 42.

For example, the shape of the surface 34 of the laptop cover 14 can be concave, and the shape of the exterior surface of the monitor 42 convex. In this way, when the laptop computer accessory 10 is in the mounted position, and the surface 34 of the laptop cover 14 is adjacent the exterior surface of the monitor 42, the laptop computer accessory 10 may be better retained on the monitor 42 of the laptop computer 40.

As discussed above and shown in FIGS. 1, 4-7 and 8, the laptop cover 14 includes the plurality of clips 16. One or more of the plurality of clips 16 can be formed integrally with the perimeter 30 of the laptop cover 14. Each of the plurality of clips 16 can extend from the perimeter 30 in a first direction away from the laptop cover 14. Referring to FIG. 1, in this example, each of the plurality of clips 16 is spaced from each other around the perimeter 30 of the laptop cover 14.

With continued reference to FIG. 1, the first end 22, the second end 24, the top end 26, and the bottom end 28 of the laptop cover 14 can define the perimeter 30. As illustrated in this example of the laptop computer accessory 10, the perimeter 30 of each of the ends 22, 24, 26 and 28 includes one or more clips of the plurality of clips 16.

One of ordinary skill in the art will nevertheless appreciate the plurality of clips 16 can be otherwise located on the laptop cover 14, e.g., on one of the ends 22, 24, 26 and 28. For example, the plurality of clips 16 may be two clips located on the top end 26 of the laptop cover 14. In this configuration, the laptop computer accessory 10 can be removably mountable on the monitor 42 of the laptop computer 40.

One or more of the plurality of clips 32 can be deformable. For example, the one or more of the plurality of clips 16 can be formed from a deformable plastic. In this way, one or more of the plurality of clips 16 can apply a compressive force to the monitor 42, e.g., the perimeter 54 of the monitor 42, when the laptop cover 14 is in the mounted position.

As discussed above, the battery 12 can be disposed within the laptop cover 14. In addition, the battery 12 may be replaceable, e.g., via the opening 20 in the laptop cover 14.

The battery 12 may also be rechargeable. For example, an electrical power source, such as a wall socket, can be placed in electrical communication with the laptop computer accessory 10, e.g., via an electrical power cord. Further, the first electrical connector 18 of the laptop computer accessory 10 can be in electrical communication with the battery 20. In this way, the wall socket can charge the battery 20 via the electrical power cord and the first electrical connector 18.

The laptop computer accessory 10 is adapted to provide electrical power from the battery 12 to, e.g., the laptop computer 40. For example, the first electrical connector 18 can be in electrical communication with the battery 12. In this way, the battery 12 can provide electrical power to the first electrical connector 18, and the first electrical connector 18 can provide the electrical power to the laptop computer 40 via, e.g., an electrical power cord.

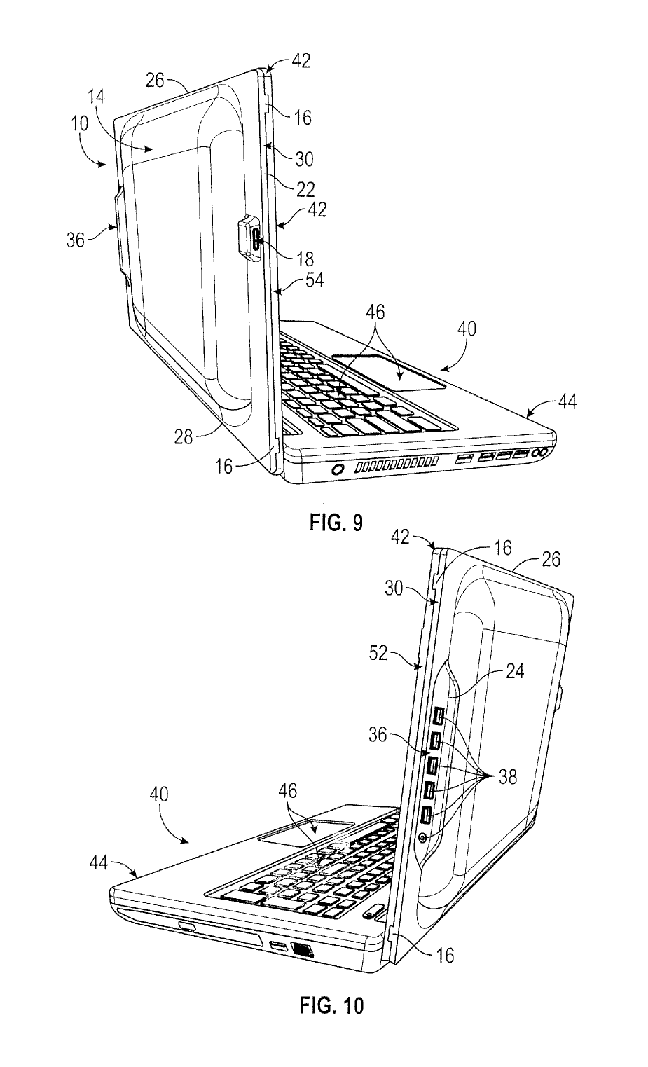

As shown in FIGS. 4 and 9, the first electrical connector 18 can be located proximate the first end 22 of the laptop cover 14. As such, when the laptop cover 14 is in the mounted position, the first electrical connector 18 can be proximate an electrical input of the laptop computer 40. As such, the battery 12 of the laptop computer accessory 10 can provide electrical power to the laptop computer 40 with, e.g., an electrical power cord having minimal length.

The laptop computer accessory 10 can include a second electrical connector 36. The second electrical connector 36 can be in electrical communication with the battery 20. Referring to FIGS. 5 and 10, the second electrical connector 36 can be located proximate the second end 24 of the laptop cover 14, opposite the first end 22.

The second electrical connector 36 can include a plurality of electric couplers 38. For example, one or more of the plurality of electric couplers 38 can include, e.g., one or more USB ports, such as a USB Type-C port, and/or one or more 20V ports. In this way, the battery 12 of the laptop cover 14 may also be used to provide power to other peripherals, such as mobile phones, media players, and the like.

As shown in FIGS. 8-10, the laptop computer 40 includes the monitor 42 supported by a base 44. The base 44 includes user input mechanisms 46, in this example, a mousepad and keyboard. The monitor 42 includes a side 48 having a screen 50, a non-screen side 52, and the perimeter 54. Referring to FIGS. 9 and 10, the surface 34 of the laptop cover 14 is adjacent the non-screen side 52 of monitor 42 when the laptop cover 14 is in the mounted position.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A laptop computer accessory comprising:
a battery disposed within or taking the form of a laptop cover;
a plurality of clips configured to removably mount the laptop cover to a monitor of a laptop computer in a mounted position, the monitor supporting the laptop cover in the mounted position; and
a first electrical connector for providing electrical power from the battery to the laptop computer.

2. The laptop computer accessory of claim 1 further comprising an opening in the laptop cover, the opening configured to allow replacement of the battery with another power source.

3. The laptop computer accessory of claim 2 further comprising a plate supported by the laptop cover, the plate moveable between a first position and a second position, the plate covering at least a portion of the opening in the first position.

4. The laptop computer accessory of claim 1, wherein the battery is rechargeable.

5. The laptop computer accessory of claim 1, wherein the monitor includes a screen, the laptop cover removably mountable to the monitor such that the screen is substantially viewable when the laptop cover is in the mounted position.

6. The laptop computer accessory of claim 5, wherein the monitor includes a screen side and a non-screen side, the laptop cover removably mounted adjacent the non-screen side when the laptop cover is in the mounted position.

7. The laptop computer accessory of claim 6, wherein the laptop cover includes a surface having a complementary shape relative a shape of a surface of the non-screen side.

8. The laptop computer accessory of claim 7 further comprising a second electrical connector for providing electrical power from the battery.

9. The laptop computer accessory of claim 8, wherein the second electrical connector includes a plurality of electric couplers.

10. The laptop computer accessory of claim 9, wherein the second plurality of couplers includes at least one USB port.

11. The laptop computer accessory of claim 8, wherein the first electrical connector is proximate a first end of the laptop cover and the second electrical connector is proximate a second end.

12. The laptop computer accessory of claim 1, wherein the laptop cover includes a perimeter and each of the plurality of clips is attached to the perimeter.

13. The laptop computer accessory of claim 12, wherein each of the plurality of clips extends from the perimeter in a first direction away from the laptop cover.

14. The laptop computer accessory of claim 12, wherein each of the plurality of clips is spaced from each other around the perimeter.

15. The laptop computer accessory of claim 12, wherein each of the plurality of clips is a deformable clip.

16. The laptop computer accessory of claim 15, wherein each of the deformable clips is configured to apply a compressive force to a perimeter of the monitor when the laptop cover is in the mounted position.

17. A laptop computer comprising:
a base having a user input mechanism;
a monitor supported by the base;
a laptop computer accessory removably mounted to the monitor, the laptop computer accessory comprising;
a battery disposed within or taking the form of a laptop cover;
a plurality of clips configured to removably mount the laptop cover to the monitor in a mounted position, the laptop cover supported by the monitor in the mounted position; and
a first electrical connector for providing electrical power from the battery to the laptop computer.
